(19) United States
(12) Patent Application Publication
(10) Pub. No.: US 2013/0024597 A1
(43) Pub. Date: Jan. 24, 2013

(54) TRACKING MEMORY ACCESS FREQUENCIES AND UTILIZATION

(71) Applicants: Gabriel H. Loh, Bellevue, WA (US); Nuwan Jayasena, Sunnyvale, CA (US)

(72) Inventors: Gabriel H. Loh, Bellevue, WA (US); Nuwan Jayasena, Sunnyvale, CA (US)

(21) Appl. No.: 13/186,066

(22) Filed: Jul. 19, 2011

(51) Int. Cl. G06F 12/08

(52) U.S. Cl. 711/3; 711/118; 711/E12.017; 711/E12.024; 711/E12.061

(57) ABSTRACT

A method is provided including recording, in a counter of a set of counters, a number of cache accesses for a page corresponding to a translation lookaside buffer (TLB) page table entry, where the counters are physically grouped together and physically separate from the TLB. The method also includes recording the number of cache accesses from the corresponding counter to a field of the page table responsive to an event. An apparatus is provided that includes a memory unit and a set of counters coupled to the one memory unit, the set of counters comprises one or more counters that are physically grouped together and are adapted to store a value indicative of a number of memory page accesses. The apparatus includes a cache coupled to the set of counters. Also provided is a computer readable storage device encoded with data for adapting a manufacturing facility to create the apparatus.

### BACKGROUND

1. Field of the Invention

Embodiments of this invention relate generally to computers and memories, and, more particularly, to a method and apparatus for tracking memory access frequencies and memory utilization for various types of memory structures.

2. Description of Related Art

Memory structures, or memory, such as Random Access Memories (RAMs), Static RAMs (SRAMs), Dynamic RAMs (DRAMs) and various levels of cache, have evolved to require increasingly faster and more efficient accesses. As memory technologies have increased in speed and usage, management of memory devices has increased in complexity. Increased demands on system performance coupled with memory management complexity now require efficient, stream-lined memory utilization.

Typically, in modern implementations for memory management, memory page access tracking is limited to a single bit: a page “accessed” or “not accessed” bit in the memory page table. Similarly, memory page “misses” cannot be adequately and quantitatively tracked. In the current state of the art, system performance considerations have not been balanced with adequate information related to the management.

### SUMMARY OF EMBODIMENTS OF THE INVENTION

In one aspect of the present invention, a method is provided. The method includes recording, in a corresponding counter of a set of counters, a number of accesses to a cache for a page corresponding to a page table entry of a translation lookaside buffer (TLB), wherein the counters of the set of counters are physically grouped together and are physically separate from the TLB and recording the number of cache accesses from the corresponding counter to a field of the page table responsive to an event.

In another aspect of the invention, an apparatus is provided. The apparatus includes at least one memory unit. The apparatus also includes a set of counters communicatively coupled to the at least one memory unit, the set of counters comprising one or more counters that are physically grouped together, the one or more counters each being adapted to store a value indicative of a number of memory page accesses. The apparatus further includes at least one cache communicatively coupled to the set of counters.

In yet another aspect of the invention, a computer readable storage device encoded with data that, when implemented in a manufacturing facility, adapts the manufacturing facility to create an apparatus is provided. The apparatus includes at least one memory unit. The apparatus also includes a set of counters communicatively coupled to the at least one memory unit, the set of counters comprising one or more counters that are physically grouped together, the one or more counters each being adapted to store a value indicative of a number of memory page accesses. The apparatus further includes at least one cache communicatively coupled to the set of counters.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 schematically illustrates a simplified block diagram of a computer system including one or more memory structures, according to one exemplary embodiment;

FIG. 2 shows a simplified block diagram of a memory device/structure, according to one exemplary embodiment;

FIG. 3 shows a simplified block diagram of a memory device/structure on a silicon chip, according to one exemplary embodiment;

FIG. 4 illustrates an exemplary detailed representation of a memory device/structure produced in a semiconductor fabrication facility, according to one exemplary embodiment;

FIG. 5A illustrates a schematic diagram of a page table entry, according to one exemplary embodiment;

FIG. 5B illustrates a schematic diagram of a memory structure and corresponding page misses, according to one exemplary embodiment;

FIG. 6A illustrates a schematic diagram of a page table entry, according to one exemplary embodiment, according to one exemplary embodiment;

FIG. 6B illustrates a schematic diagram of a memory structure and corresponding page misses, according to one exemplary embodiment; and

FIG. 7 illustrates a memory tracking flowchart, according to one exemplary embodiment.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As used herein, the terms “substantially” and “approximately” may mean within 85%, 90%, 95%, 98% and/or 99%. In some cases, as would be understood by a person of ordinary skill in the art, the terms “substantially” and “approximately” may indicate that differences, while perceptible, may be negligent or be small enough to be ignored. Additionally, the term “approximately,” when used in the context of one value being approximately equal to another, may mean that the values are “about” equal to each other. For example, when measured, the values may be close enough to be determined as equal by one of ordinary skill in the art.

It is contemplated that various embodiments described herein are not mutually exclusive. That is, the various embodiments described herein may be implemented simultaneously with, or independently of, each other, as would be apparent to one of ordinary skill in the art having the benefit of this disclosure.

Embodiments of the present invention may generally provide for efficient management and utilization of memory structures and memory devices (e.g., RAMs, SRAMs, DRAMs, cache and the like). There may be situations where it is desirable to know the exact (or reasonably close) number of last-level cache misses for each page of memory. One example where this information may be useful is in systems employing a non-uniform memory access (NUMA) latency memory system where some pages have faster access latencies than others. Knowledge of which memory pages generate the most misses (and how many misses) from the last-level cache may aid the operating system (“OS”) in deciding which pages should be mapped to which address ranges, and whether pages should be re-mapped. The embodiments described herein may be implemented in non-uniform memory access (“NUMA”) systems and/or uniform memory access systems.

Modern processors (e.g., CPUs, GPUs, and/or the like) may employ a logic block called a page table walker (“PTW”) that may be adapted for handling translation lookaside buffer (“TLB”) misses. A given processor may have a fixed convention for how the operating system (“OS”) should lay out its memory page tables, and for how the processor uses hardware registers to point at the base addresses of the various page table data structures. If the OS organizes a page table following the processor's conventions, the PTW may automatically look up page table entries (“PTEs”) on a TLB miss without OS intervention. Memory page tables and PTWs are known in the art and, for the sake of clarity in describing the embodiments herein, are not discussed in detail.

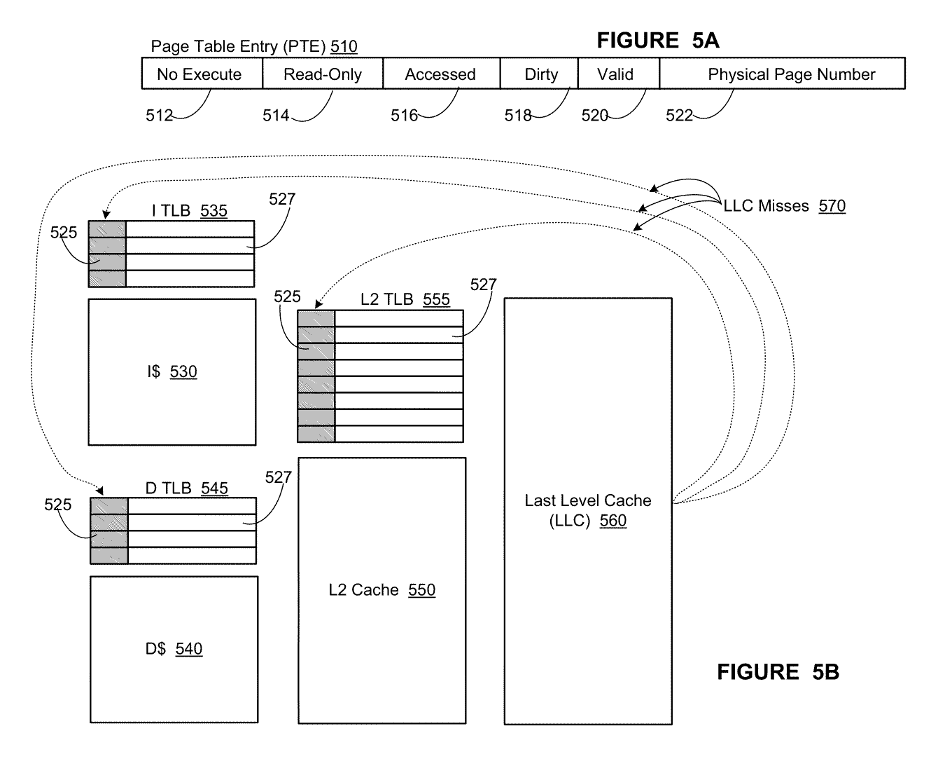

Embodiments described herein propose to modify the format of the PTE to include a new field that records the number of misses (e.g., in a last level cache (“LLC”)) to the associated page in memory. While embodiments herein may be described in terms of an LLC, these embodiments may be implemented using other memory components as well (e.g., a level two (L2) cache). Similarly, the number of levels of cache may vary in one or more embodiments described herein; that is, in alternate embodiments, varying levels of cache may be used. Conceptually, each TLB entry may also augmented with this additional field to store the LLC miss count, and a counter may be incremented by hardware (or software) in a system on each LLC miss. A counter may be implemented for each TLB entry. Physically placing the counter directly in each TLB entry (as shown in FIG. 5B below) is problematic for several reasons. First, the TLB traffic increases because each LLC miss now results in an extra read-modify-write of the corresponding TLB entry, leading to port contention that stalls real load and store lookups. Second, a new TLB access path from the LLC must be added (as shown in FIG. 5B (570) below), leading to more complexity in the TLB access arbitration logic and potentially impacting the performance-critical DL1/DTLB timing paths. Third, the LLC is physically distant from the multiple TLBs (ITLB, DTLB, L2TLB if applicable, and then multiplied by the number of cores) (as shown in FIG. 5B below), thus several long global wires/traces must be added which can lead to routing congestion in the physical design.

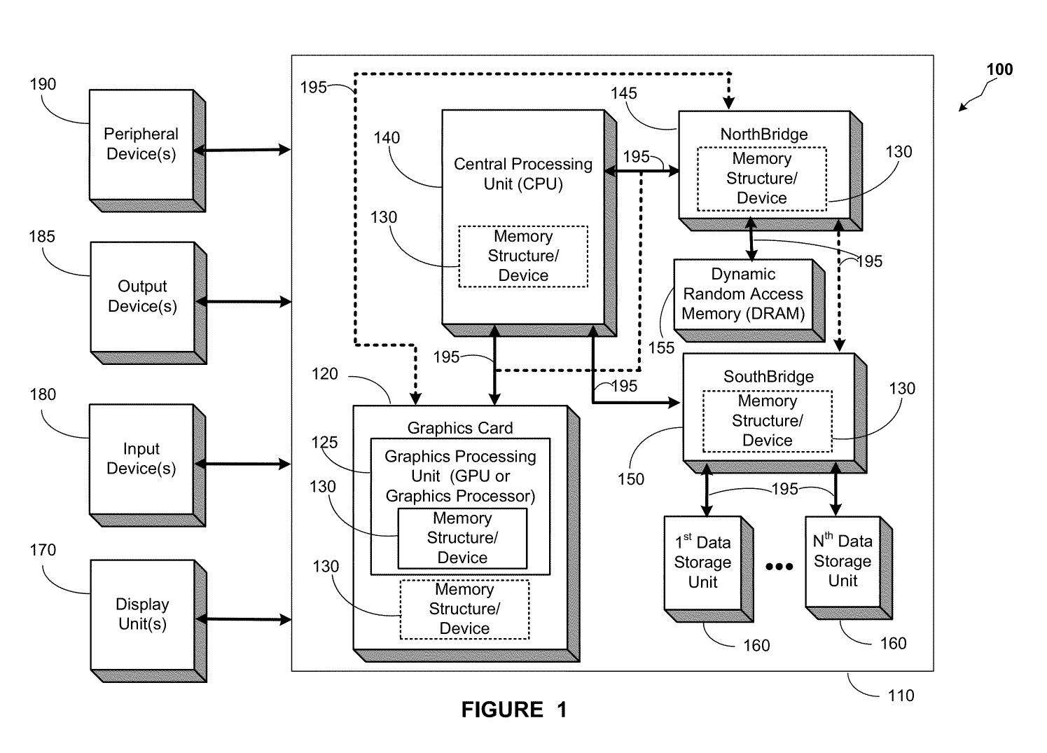

Turning now to FIG. 1, a block diagram of an exemplary computer system 100, in accordance with an embodiment of the present invention, is illustrated. In various embodiments the computer system 100 may be a personal computer, a laptop computer, a tablet computer, a handheld computer, a mobile device, a telephone, a personal data assistant (PDA), a server, a mainframe, a work terminal, or the like. The computer system includes a main structure 110 which may be a computer motherboard, circuit board or printed circuit board, a desktop computer enclosure and/or tower, a laptop computer base, a server enclosure, part of a mobile device, personal data assistant (PDA), or the like. In one embodiment, the main structure 110 includes a graphics card 120. In one embodiment, the graphics card 120 may be a Radeon™ graphics card from Advanced Micro Devices (“AMD”) or any other graphics card using memory, in alternate embodiments. The graphics card 120 may, in different embodiments, be connected on a Peripheral Component Interconnect (PCI) Bus (not shown), PCI-Express Bus (not shown) an Accelerated Graphics Port (AGP) Bus (also not shown), or any other connection known in the art. It should be noted that embodiments of the present invention are not limited by the connectivity of the graphics card 120 to the main computer structure 110. In one embodiment, computer runs an operating system such as Linux, Unix, Windows, Mac OS, or the like.

In one embodiment, the graphics card 120 may contain a graphics processing unit (GPU) 125 used in processing graphics data. The GPU 125, in one embodiment, may include a memory structure 130. In one embodiment, the memory structure 130 may be an embedded random access memory (RAM), an embedded static random access memory (SRAM), or an embedded dynamic random access memory (DRAM). In one or more embodiments, the memory structure 130 may be an embedded RAM (e.g., an SRAM). In alternate embodiments, the memory structure 130 may be embedded in the graphics card 120 in addition to, or instead of, being embedded in the GPU 125. In various embodiments the graphics card 120 may be referred to as a circuit board or a printed circuit board or a daughter card or the like.

In one embodiment, the computer system 100 includes a central processing unit (CPU) 140, which is connected to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other connection as is known in the art. For example, CPU 140, northbridge 145, GPU 125 may be included in a single package or as part of a single die or “chips”. Alternative embodiments which alter the arrangement of various components illustrated as forming part of main structure 110 are also contemplated. The CPU 140 and/or the northbridge 145, in certain embodiments, may each include a memory structure 130 in addition to other memory structures 130 found elsewhere in the computer system 100. In certain embodiments, the northbridge 145 may be coupled to a system RAM (or DRAM) 155; in other embodiments, the system RAM 155 may be coupled directly to the CPU 140. The system RAM 155 may be of any RAM type known in the art; the type of RAM 155 does not limit the embodiments of the present invention. In one embodiment, the northbridge 145 may be connected to a southbridge 150. In other embodiments, the northbridge 145 and southbridge 150 may be on the same chip in the computer system 100, or the northbridge 145 and southbridge 150 may be on different chips. In one embodiment, the southbridge 150 may have a memory structure 130, in addition to any other memory structures 130 elsewhere in the computer system 100. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125, DRAM 155 and/or memory structure 130 may be a computer chip or a silicon-based computer chip, or may be part of a computer chip or a silicon-based computer chip. In one or more embodiments, the various components of the computer system 100 may be operatively, electrically and/or physically connected or linked with a bus 195 or more than one bus 195.

In different embodiments, the computer system 100 may be connected to one or more display units 170, input devices 180, output devices 185 and/or other peripheral devices 190. It is contemplated that in various embodiments, these elements may be internal or external to the computer system 100, and may be wired or wirelessly connected, without affecting the scope of the embodiments of the present invention. The display units 170 may be internal or external monitors, television screens, handheld device displays, and the like. The input devices 180 may be any one of a keyboard, mouse, track-ball, stylus, mouse pad, mouse button, joystick, scanner or the like. The output devices 185 may be any one of a monitor, printer, plotter, copier or other output device. The peripheral devices 190 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like. To the extent certain exemplary aspects of the computer system 100 are not described herein, such exemplary aspects may or may not be included in various embodiments without limiting the spirit and scope of the embodiments of the present invention as would be understood by one of skill in the art.

In one embodiment, any number of computer systems 100 may be communicatively coupled and/or connected to each other through a network infrastructure. In various embodiments, such connections may be wired or wireless without limiting the scope of the embodiments described herein. The network may be a local area network (LAN), wide area network (WAN), personal network, company intranet or company network, the Internet, or the like. In one embodiment, the computer systems 100 connected to the network via the network infrastructure may be a personal computer, a laptop computer, a handheld computer, a tablet computer, a mobile device, a telephone, a personal data assistant (PDA), a server, a mainframe, a work terminal, any other computing device described herein, and/or the like. The number of computers connected to the network may vary; in practice any number of computer systems 100 maybe coupled/connected using the network.

In one embodiment, computer systems 100 may include one or more graphics cards. The graphics cards 120 may contain a graphics processing unit (GPU) 125 used in processing graphics data. The GPU 125, in one embodiment, may include a memory structure 130. In one embodiment, the memory structure 130 may be an embedded static random access memory (SRAM). In one or more embodiments, the memory structure 130 may include embedded ECC logic. In alternate embodiments, the memory structure 130 may be embedded in the graphics card 120 in addition to, or instead of, being embedded in the GPU 125. In another embodiment, the graphics card 120 may include a non-embedded memory, for example a dynamic RAM (DRAM) in addition to any memory structures 130. The graphics card 120 may also include one or more display interfaces. To the extent certain exemplary aspects of the graphics card 120 are not described herein, such exemplary aspects may or may not be included in various embodiments without limiting the spirit and scope of the embodiments of the present invention as would be understood by one of skill in the art. In one embodiment, the graphics processing unit 125 and memory structure 130 may reside on the same silicon chip as the CPU 140 and the northbridge 145. In one alternate embodiment, the graphics processing unit 125 and memory structure 130 may reside on the same silicon chip as the CPU 140. In such embodiments, the silicon chip(s) may be used in a computer system 100 in place of, or in addition to, the graphics card 120. The silicon chip(s) may be housed on the motherboard (not shown) or other structure of the computer system 100.

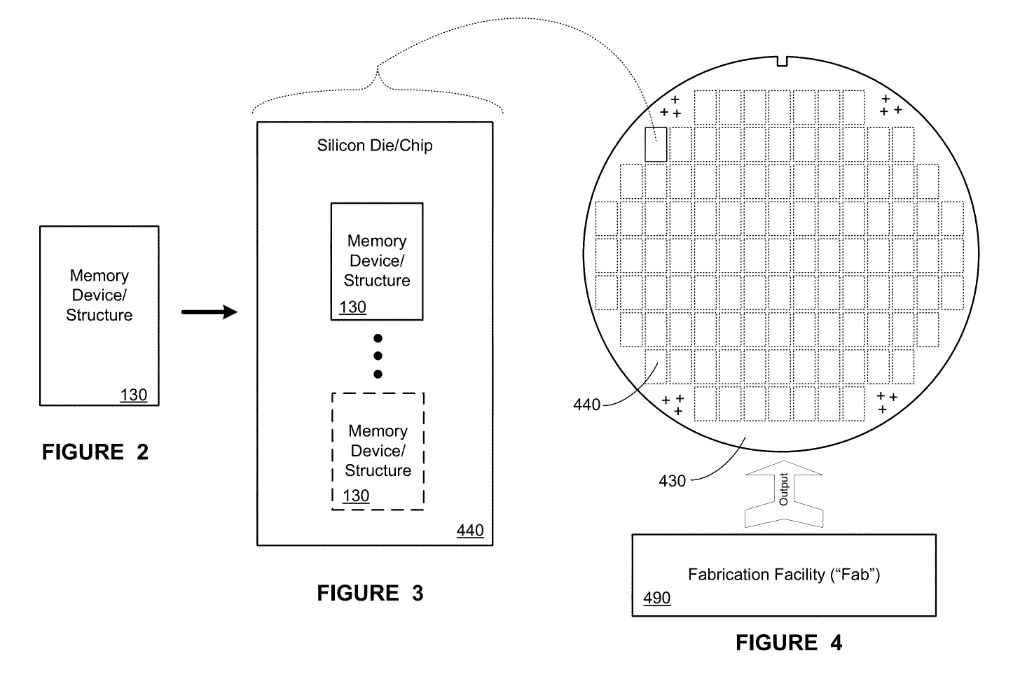

Turning now to FIG. 2, a simplified, exemplary representation of the memory structure 130, which may be used in silicon die/chips 440, as well as devices depicted in FIG. 1, according to one embodiment is illustrated. However, those skilled in the art will appreciate that the memory structure 130 may take on any of a variety of forms, including those previously described above, without departing from the spirit and scope of the instant invention. The memory structure 130 may be implemented as single elements (130) or in arrays or in other groups (not shown). The memory structure 130 may comprise various logic circuits for controlling, managing and utilizing memory functionality, as will be described below in greater detail.

Turning to FIG. 3, the silicon die/chip 440 is illustrated as comprising one or more memory structures 130, and/or any other configuration of memory structures 130 as would be apparent to one of skill in the art having the benefit of this disclosure. As discussed above, various embodiments of memory structures 130 may be used in a wide variety of electronic devices, including, but not limited to, central and graphics processors, motherboards, graphics cards, combinatorial logic implementations, register banks, memory, other integrated circuits (ICs), application specific integrated circuits (ASICs), programmable logic devices, and/or the like.

Turning now to FIG. 4, in accordance with one embodiment, and as described above, one or more of the memory structures 130 may be included on the silicon die/chips 440 (or computer chips). The silicon die/chips 440 may contain one or more different configurations of the memory structures 130 (e.g., one or more RAMs or cache structures). The silicon chips 440 may be produced on a silicon wafer 430 in a fabrication facility (or “fab”) 490. That is, the silicon wafers 430 and the silicon die/chips 440 may be referred to as the output, or product of, the fab 490. The silicon die/chips 440 may be used in electronic devices, such as those described above in this disclosure.

Exemplary implementations for memory management, such as those illustrated in FIGS. 5A and 5B, may require full-scale page counters to track hits and misses of every memory page, and the use of such counters may undermine system performance due to processor overhead and other considerations such as physical area needed by these counters and routing all the associated signals. Such exemplary implementations may attempt to alleviate this problem by mapping a designated range of physical memory that an operating system (“OS”) could access, however, such implementations may require extra complexity during system boot up and/or configuration as some portion of the physical memory address space must be allocated for the tracking table in the mapped memory region. Complications may further arise in that an OS must be able to support systems with and without such a tracking table in the mapped memory region.

Turning now to FIG. 5A, a diagram of an exemplary implementation of a page table entry (PTE) 510 associated with a memory structure is illustrated. It should be noted that alternate implementations of the PTE 510 are contemplated and such alternate implementations may contain additional or alternate PTE 510 fields. The PTEs 510 may be stored in a page table (not shown). A translation lookaside buffer (“TLB”) may map the PTE 510 entries with the memory page table (not shown). The PTE 510 may comprise one or more fields, where each field may comprise one or more bits. As illustrated, the PTEs 510 may have a “no execute” field 512 for indicating that the processor 125/140 is not allowed to interpret data from the associated memory page as an instruction. The PTEs 510 may have a “read-only” field 514 to indicate if the memory page is read-only or is writable. The PTEs 510 may have an “accessed” field 516 to indicate if the memory page has been accessed. The PTEs 510 may have a “dirty” field 518 to indicate of the memory page has been written to. If the dirty field is set, the OS must write the contents of the memory page to a storage disk upon eviction of the page from memory. The PTEs 510 may have a “valid” field 520 to indicate if the data in the memory page is valid data. The PTEs 510 may also have a “physical page number” field 522 to indicate the number of the physical page in memory associated with the PTE 510.

Turning now to FIG. 5B, a diagram of an implementation of memory tracking associated with a memory structure is illustrated. As illustrated, exemplary implementations of memory access tracking may comprise one or more translation lookup buffers (TLBs) associated with one or more memory structures (e.g., RAMs and/or caches). As shown in FIG. 5B, a memory structure or system may have one or more memory units such as an instruction cache (IS) memory unit 530 (a level one (L1) cache), a data cache (D$) memory unit 540 (a level one (L1) cache), an L2 cache 550 and/or an LLC 560. One or more memory units may have an associated TLB. For example, the I$ memory unit 530 may have an associated ITLB 535, the D$ memory unit 540 may have an associated DTLB 545, and the L2 cache 550 (or other caches as shown or not shown) may have an associated L2TLB 555. The associated TLBs (535, 545, 555) may each comprise one or more entries 527. In order to track memory usage, a counter 525 may be implemented for each associated TLB (535, 545, 555) entry 527. When a page in memory is accessed, the counter 525 may be incremented and the PTE 510 fields may be updated accordingly.

If all TLB (535, 545, 555) entries are valid and in use, and a TLB (535, 545, 555) miss occurs when the processor 125/140 attempts an access, the page table walker (“PTW”) (not shown) may evict one of the associated TLB (535, 545, 555) entries (i.e., one of the PTEs 510 of that TLB). The PTW may write the PTE 510 back to the page table in memory so that the updated states of the dirty and accessed bits are propagated to the page table and therefore become visible to the OS. The PTW may read in the new PTE 510 corresponding to the original TLB (535, 545, 555) miss. In various embodiments, the write back of the PTE 510 may occur at any other time, not just after an eviction of an associated TLB (535, 545, 555) entry. Similarly, values may be written back to the counters 525 by including the values in existing data transmission operations that transmit data to the TLB (535, 545, 555) entries.

As shown in FIG. 5B, physically placing the counter 525 directly in each associated TLB (535, 545, 555) entry 527, i.e., PTE 510, (as shown in FIG. 5B) may be problematic for several reasons. First, the TLB (535, 545, 555) traffic increases because each LLC miss 570 now results in an extra read-modify-write of the corresponding TLB (535, 545, 555) entry 527, leading to port contention that stalls real load and store lookups. Second, a new TLB access path for LLC misses 570 from the LLC must be added, leading to more complexity in any TLB (535, 545, 555) access arbitration logic and potentially impacting any performance-critical data cache 540 and DTLB 545 timing paths. This may also increase the overhead on the processor 125/140 and the OS. Third, the LLC 550 is physically distant from the multiple TLBs (535, 545, 555), and these complexities may be multiplied by the number of cores present in the system. For example, if a processor 125/140 has two cores, the number of associated TLBs (535, 545, 555), and any associated routing, will be increased. Thus several long global wires/traces must be added to the system (as the LLC 550 must report any misses 570), as shown in FIG. 5B, which can lead to routing congestion in the physical design.

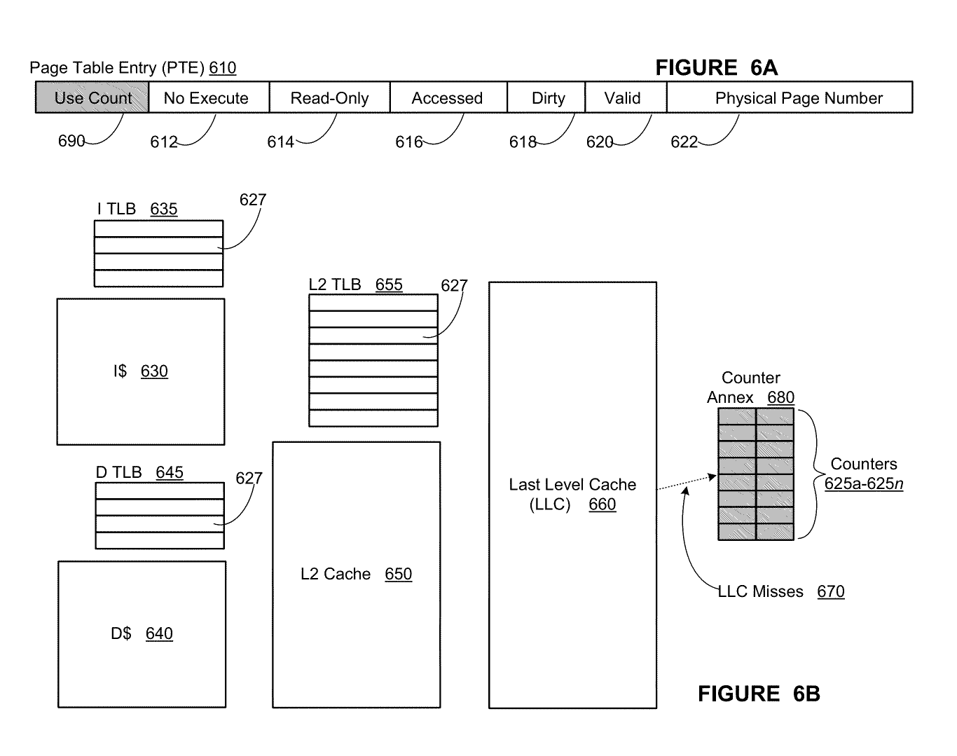

Turning now to FIG. 6A, a diagram of an implementation of a page table entry (PTE) 610 associated with a memory structure is illustrated. The PTEs 610 may be stored in a page table (not shown). A translation lookup buffer (“TLB”) maps the PTE 610 entries with the memory page table (not shown). The PTE 610 may comprise one or more fields, where each field may comprise one or more bits. It should be noted that alternate implementations of the PTE 610 are contemplated and such alternate implementations may contain additional or alternate PTE 610 fields. As illustrated, the PTEs 610 may have a “no execute” field 612 for indicating that the processor 125/140 is not allowed to interpret data from the associated memory page as an instruction. The PTEs 610 may have a “read-only” field 614 to indicate if the memory page is read-only or is writable. The PTEs 610 may have an “accessed” field 616 to indicate if the memory page has been accessed. The PTEs 610 may have a “dirty” field 618 to indicate of the memory page has been written to. If the dirty field is set, the OS must write the contents of the memory page to a storage disk upon eviction of the page from memory. The PTEs 610 may have a “valid” field 620 to indicate if the data in the memory page is valid data. The PTEs 610 may also have a “physical page number” field 622 to indicate the number of the physical page in memory associated with the PTE 610. Additionally, the PTEs 610 may comprise a “use count” field 690. The use count field 690 may comprise one or more bits adapted to act as a counter for keeping track of how many times the associated memory page is accessed. In one embodiment, the count field 690 may be adapted to store any value indicative of the number of accesses or misses. The stored value may, in some embodiments, be a function of the number of accesses or misses.

Turning now to FIG. 6B, in accordance with one or more embodiments of the present invention, an exemplary schematic diagram of a portion of the memory structure 130 is illustrated. As illustrated herein, implementations for memory access tracking may comprise one or more translation lookup buffers (TLBs) associated with one or more memory structures (e.g.,

RAMs and/or caches). In one embodiment, a memory structure or system may have one or more memory units such as an instruction cache (IS) memory unit 630 (a level one (L1) cache), a data cache (D$) memory unit 640 (a level one (L1) cache), an L2 cache 650 and/or a last level cache (LLC) 660. In one embodiment, the one or more memory units may have an associated TLB. In one or more embodiments, the I$ memory unit 630 may have an associated ITLB 635, the D$ memory unit 640 may have an associated DTLB 645, and the L2 cache 650 may have an associated L2TLB 655. The associated TLBs (635, 645, 655) may each comprise one or more entries 627. In order to track memory usage, one or more counters (625a-625n) may be implemented for associated each TLB (635, 645, 655) entry 627. The respective counters 625a-n may be physically or logically grouped together in a counter annex 680. In one or more embodiments, the counter annex 680 may comprise a set of counters, table of counters, group and/or list of counters 625a-n from one or more memory units (e.g., a combination of I$ 630, D$ 640 and/or L2 cache 650), where the counters 625a-n are physically grouped together. In alternate embodiments, the counter annex 680 may comprise other organizational structures, as would be known in the art. In one embodiment, the counter annex 680 may be located near the LLC 660. In various embodiments, the proximity of the counter annex 680 to the LLC 660 may be super-adjacent, adjacent, within a distance such that a connection does not require buffering, within a distance such that a connection may be traversed within less than one clock period (for a clock speed of 25 MHz, 50 MHz, 100 MHz, 200 MHz, 400 MHz, 800 MHz and/or >1 GHz), and/or within a distance that is less than 1%, 2%, 5% and/or 10% of the total silicon die area. In alternate embodiments, the counter annex 680 may be located elsewhere in the silicon die or on a separate chip. In one or more embodiments, the counter annex 680 may be located separately (i.e., physically separate) from the TLBs (635, 645, 655). For example, the counter annex 680 may be stored in a separate register, register bank, memory component and/or physical area of the silicon chip/die from the TLBs (635, 645, 655). When a page in memory is accessed, the associated counter 625a-n may be incremented.

Updating the PTE 610 fields may be performed at predetermined intervals or when the processor 125/140 (or a controller) and/or the OS request counter 625a-n values in an attempt to determine memory usage (e.g., memory table accesses, hits and/or misses 670). For example, the processor 125/140 and/or the OS may look to a given page table entry to determine usage, hits and/or misses 670 for that page table. The proximity of the counter annex 680 to the LLC 660 may allow for updating of the counters 625a-n via a short path that requires relatively low routing overhead and processor/OS management and/or overhead. When the processor 125/140 and/or the OS make an inquiry for the memory usage of one or more memory pages, one or more counter 625a-n values may be sent from the counter annex 680 in response to the inquiry (or periodically, in some embodiments). That is, the processor 125/140 and/or the OS may obtain some or all of the counter 625a-n values in one transaction, thus incurring less overhead system-wide (and/or less overhead specifically related to the processor 125/140 and/or OS). The counter 625a-n values may be updated to (i.e., written into) the PTEs 610 for the respective memory pages by writing the values from the counters 625a-n into the use count 690 field of the PTEs 610. By allocating the use count 690 field into the existing PTEs 610, the efficiency of the utilization tracking process illustrated above may be further increased.

In other words, in one or more embodiments, the counter annex 680 may separate the logical per-entry counters 625a-n from their associated TLBs (e.g., 635, 645, 655) into a separate physical table. The table may be located near the LLC 660 and thus near the LLC 660 miss handling logic (not shown), as exemplarily shown in FIG. 6B, so that it may be easily accessible on an LLC miss 670 and avoid the implementation issues raised above with respect to FIGS. 5A-5B. The overhead in each entry to the counter annex 660 is relatively small (entries may have a tag/physical page number field to facilitate lookups, causing TLB tags to be replicated (once in the original TLB (e.g., 635, 645, 655) entry 627 and once again in the counter annex 660)). The counter annex 660 may maintain the inclusion property for each other TLB (e.g., 635, 645, 655) in the system, although this may be easily accomplished by statically partitioning the counter annex 680 entries to maintain a one-to-one correspondence to the individual TLB (e.g., 635, 645, 655) entries.

Loads and stores that hit in the on-chip caches may access the normal TLBs (e.g., 635, 645, 655) to obtain their translations, but they need not access the counter annex 680. On an LLC miss 670, the physical memory page may be looked up in the counter annex and the matching entry's counter may be incremented. Eventually when the corresponding TLB (635, 645, 655) entry 627 is evicted from the processor core's TLB (not shown), the hardware page table walker (PTW) may transfer the TLB's dirty and accessed bits back to the memory copy of the corresponding PTE 610. In one or more embodiments, the counter 625a-n values field held in the counter annex 680 may also need to be written back to the in-memory copy of the respective PTE 610. The PTW logic may acquire the counter value from the counter annex 680, and write it back with the other bits in a single operation (or in multiple operations). For example, this may be accomplished by including one or more counter values with the existing dirty/accessed-bit write-back procedure. It should be noted that while not described herein, the counter value(s) may be written back using other operations, as would become apparent to one of skill in the art having the benefit of this disclosure. In various embodiments, the write back of the PTE 610 may occur at any other time, not just after an eviction of an associated TLB (635, 645, 655) entry. Similarly, values may be written back from the counter(s) 625a-n by including the values in existing data transmission operations that transmit data to the TLB (635, 645, 655) entries.

As a result, the page table may maintain accurate LLC-miss counts for every page in the system (modulo a TLB walk-through to extract any counter 625a-n values that have not been written back to memory from the on-chip counter annex 680), but the hardware overhead is only proportional to the existing TLB (e.g., 635, 645, 655) sizes. For example, an eight-core processor with 32-entry instruction and data TLBs (e.g., 635, 645) and a 256-entry L2 TLB (655) may only require 20 KB of storage to implement a fully-inclusive counter annex 680 with 16-bit counters and 48-bit tags (which may overly conservative, as would be apparent to one of skill in the art having the benefit of this disclosure).

Given the number of miss counts that may be stored in the in-memory page table entries, the operating system can, for example, use this information to determine which pages were responsible for the greatest amount of main memory traffic and then remap the pages to locations that reduce latency, power and/or any other measurable memory characteristic. This may be particularly important for current and/or future systems with multiple disparate memories, such CPU DDR3, GPU GDDR5, die-stacked (in-package) memories, and/or the like. This may also be useful in conventional multi-socket NUMA systems. Also, as noted above, alternate embodiments may allow for varying numbers of cache levels, and the embodiments contemplated herein are not limited to a set number of cache levels.

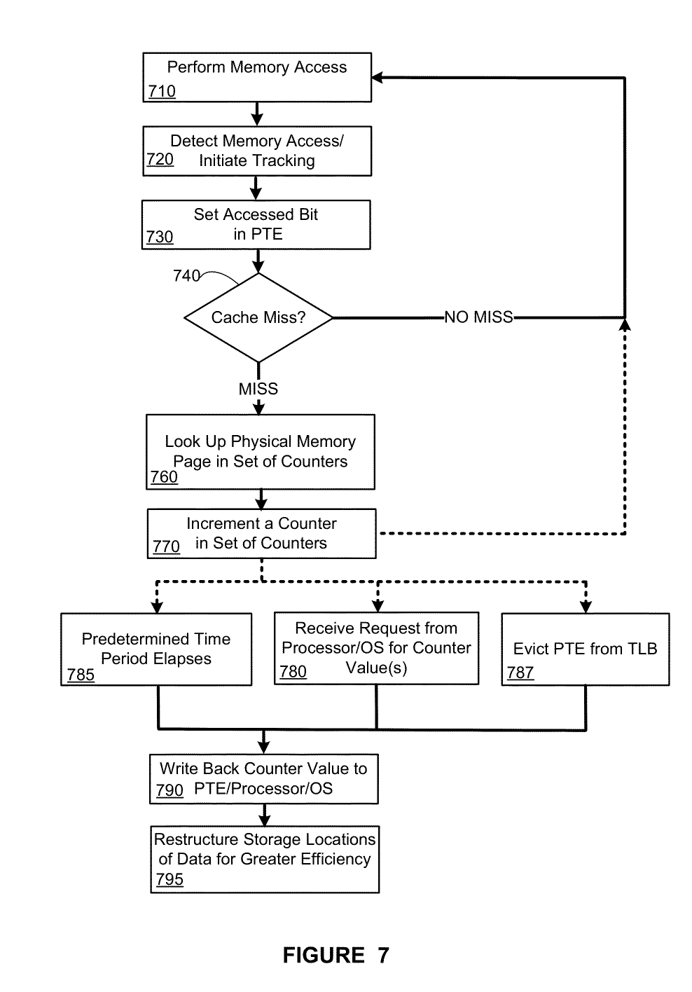

Turning now to FIG. 7, in accordance with one or more embodiments, a flowchart depicting a memory tracking process is shown. At step 710, a memory access may be performed by the processor 125/140 and/or the OS. The memory access may be detected and memory tracking may be initiated (step 720). The PTE 610 accessed bit 616 may be set (step 730) and a determination may be made if the memory access resulted in a cache hit or an LLC 660 miss (step 740). If it is determined (at step 740) that a cache miss has not occurred, the flow may proceed back to the first step of performing a memory access (step 710). If it is determined (at step 740) that a cache miss has occurred, the flow may proceed to looking up the appropriate physical memory page entry in the counter annex 660 (step 760). Once the physical page entry is located, the counter 625a-n may be incremented indicating a miss for that physical address (step 770). From step 770, the flow may, proceed back to the first step of performing a memory access (step 710). Alternatively, if the processor 125/140 and/or the OS request the value of one or more counters 625a-n from the counter annex 660, the flow may proceed from step 770 to step 780 where the request is received and processed. Alternatively, if a predetermined time period has passed (step 785), this may be an indication that the values of the one or more counters 625a-n from the counter annex 660 should be transmitted (e.g., via inclusion in a write-back operation) to the appropriate PTEs 610, the processor 125/140 and/or the OS. The flow may also proceed from step 780 to step 787 where the PTE 610 may be evicted from its corresponding TLB (635, 645, 655). It should be noted that step 787 may be performed in parallel to either (or both) of steps 780 and/or 785, or before or after either of steps 780 and/or 785. From either step 780, step 785 or step 787, the flow may proceed to writing back the counter 625a-n value(s) (step 790). Based upon the counter 625a-n value(s), the processor 125/140 and/or the OS may restructure/reorganize data in one or more the memory units (630, 640, 650) in order to more efficiently handle frequently accessed data (step 795).

It is contemplated that the steps illustrated in FIG. 7 may be performed in parallel (or at least partially temporally overlapping) or in an order different than that which is illustrated, as would be apparent to one of ordinary skill in the art having the benefit of this disclosure. The ordering of the steps in FIG. 7 is illustrative of one contemplated embodiment and is exemplary in nature, and the embodiments herein may be utilized in a manner that executes the steps of FIG. 7 in one or more alternate sequences.

It is also contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units 160, memory structures 130, compact discs, DVDs, solid state storage and the like). In one embodiment, the GDSII data (or other similar data) may be adapted to configure a manufacturing facility (e.g., through the use of mask works) to create devices capable of embodying various aspects of the instant invention. In other words, in various embodiments, this GDSII data (or other similar data) may be programmed into a computer 100, processor 125/140 or controller, which may then control, in whole or part, the operation of a semiconductor manufacturing facility (or fab) to create semiconductor products and devices. For example, in one embodiment, silicon wafers containing memory devices/structures 130 may be created using the GDSII data (or other similar data).

It should also be noted that while various embodiments may be described in terms of caches and memory for processors, it is contemplated that the embodiments described herein may have a wide range of applicability, not just for caches and memory for processors, as would be apparent to one of skill in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design as shown herein, other than as described in the claims below. It is therefore evident that the particular embodiments disclosed above may be altered or modified and all such variations are considered within the scope and spirit of the claimed invention.

Accordingly, the protection sought herein is as set forth in the claims below.

What is claimed:

1. A method comprising:
recording, in a corresponding counter of a set of counters, a number of accesses to a cache for a page corresponding to a page table entry of a translation lookaside buffer (TLB), wherein the counters of the set of counters are physically grouped together and are physically separate from the TLB; and
recording the number of cache accesses from the corresponding counter to a field of the page table responsive to an event.

2. The method of claim 1, further comprising:
performing at least one memory page access;
detecting the at least one memory page access; and
determining that the at least one memory page access resulted in a cache miss.

3. The method of claim 1, wherein the event is at least one of an inquiry from at least one of a processor, a controller or an operating system.

4. The method of claim 1, wherein the event is a periodic interval.

5. The method of claim 1, wherein at least one of the number of accesses comprises a cache miss, and wherein recording the number of accesses to a cache comprises incrementing the counter based at least upon a signal received from at least one cache level.

6. The method of claim 1, wherein recording the number of accesses to a cache comprises incrementing the counter value a plurality of times.

7. The method of claim 1, further comprising:
transmitting the counter value to a page table entry using an existing write-back operation.

8. An apparatus that comprises:
at least one memory unit;
a set of counters communicatively coupled to the at least one memory unit, the set of counters comprising one or more counters that are physically grouped together, the one or more counters each being adapted to store a value indicative of a number of memory page accesses; and
at least one cache communicatively coupled to the set of counters.

9. The apparatus of claim 8, where the apparatus further comprises:
at least one translation lookaside buffer communicatively coupled to, and related to, each of the at least one memory units.

10. The apparatus of claim 9, wherein:
the at least one cache is at least one of a level one (L1) cache, a level two (L2) cache or a last level cache (LLC);
the at least one translation lookaside buffer comprises one or more entries; and
the one or more counters comprises a counter corresponding to each of the one or more entries of at least one translation lookaside buffer.

11. The apparatus of claim 9, wherein the set of counters is located physically separately from the at least one translation lookaside buffer.

12. The apparatus of claim 8, where the apparatus further comprises:
a page table entry storage device communicatively coupled to at least one of the at least one memory unit or the at least one cache and communicatively coupled to the set of counters, the page table entry storage device being adapted to store at least one page table entry.

13. The apparatus of claim 12, wherein the page table entry storage device comprises at least one counter value storage portion.

14. A computer readable storage device encoded with data that, when implemented in a manufacturing facility, adapts the manufacturing facility to create an apparatus, where the apparatus comprises:
at least one memory unit;
a set of counters communicatively coupled to the at least one memory unit, the set of counters comprising one or more counters that are physically grouped together, the one or more counters each being adapted to store a value indicative of a number of memory page accesses; and
at least one cache communicatively coupled to the set of counters.

15. A computer readable storage device, as set forth in claim 14, encoded with data that, when implemented in a manufacturing facility, adapts the manufacturing facility to create an apparatus, where the apparatus further comprises:
at least one translation lookaside buffer communicatively coupled to, and related to, each of the at least one memory units.

16. A computer readable storage device, as set forth in claim 15, encoded with data that, when implemented in a manufacturing facility, adapts the manufacturing facility to create an apparatus, wherein:
the at least one cache comprises at least one of a level one (L1) cache, a level two (L2) cache or a last level cache (LLC);
the at least one translation lookaside buffer comprises one or more entries; and
the one or more counters comprises a counter corresponding to each of the one or more entries of at least one translation lookaside buffer.

17. A computer readable storage device, as set forth in claim 15, encoded with data that, when implemented in a manufacturing facility, adapts the manufacturing facility to create an apparatus, wherein the set of counters is located physically separately from the at least one translation lookaside buffer.

18. A computer readable storage device, as set forth in claim 14, encoded with data that, when implemented in a manufacturing facility, adapts the manufacturing facility to create an apparatus, where the apparatus further comprises:
a page table entry storage device communicatively coupled to at least one of the at least one memory unit or the at least one cache and communicatively coupled to the set of counters, the page table entry storage device being adapted to store at least one page table entry.

19. A computer readable storage device, as set forth in claim 18, encoded with data that, when implemented in a manufacturing facility, adapts the manufacturing facility to create an apparatus wherein the page table entry storage device comprises at least one counter value storage portion.

20. A computer readable storage device, as set forth in claim 18, encoded with data that, when implemented in a manufacturing facility, adapts the manufacturing facility to create an apparatus wherein the apparatus is a component of a computing system.
